(19) United States
(12) Patent Application Publication
(10) Pub. No.: US 2022/0400871 A1
(43) Pub. Date: Dec. 22, 2022

(54) Self-Adjusting Chair Using Measurements of Occupant

(71) Applicant: Bayerische Motoren Werke Aktiengesellschaft, Muenchen (DE)

(72) Inventors: Min Daw LEE, Westlake Village, CA (US); Adil ALI, Newbury Park, CA (US); Andre Hugues DE SALIS, Pasadena, CA (US)

(21) Appl. No.: 17/349,567

(22) Filed: Jun. 16, 2021

(51) Int. Cl. A47C 31/12; A47C 27/08; A47C 7/74; A47C 31/00; G01L 5/00; G01N 27/04; G01K 13/00; G01P 13/00; G01D 5/12; G01S 17/88; G06K 9/00; G05B 19/4155

(52) U.S. Cl. CPC A47C 31/126; A47C 27/083; A47C 7/742; A47C 31/008; A47C 7/748; G01L 5/00; G01N 27/041; G01K 13/00; G01P 13/00; G01D 5/12; G01S 17/88; G06K 9/00362; G06K 9/00302; G05B 19/4155; A47B 13/081

(57) ABSTRACT

A system including a self-adjusting chair is provided. The system includes a chair that is configured to be adjustable to an occupant. The system also includes a plurality of sensors, wherein each sensor of the plurality of sensors is configured to measure a characteristic of the occupant and to transmit a signal that indicates the characteristic of the occupant. In addition, the system includes a plurality of actuators, wherein each actuator of the plurality of actuators is configured to adjust a property of the chair. Further, the system includes a controller that is configured to receive at least one signal from at least one sensor of the plurality of sensors and to instruct at least one actuator of the plurality of actuators to adjust at least one property of the chair based on at least one characteristic of the occupant.

### BACKGROUND AND SUMMARY OF THE INVENTION

The present invention relates to a self-adjusting chair that uses measurements of an occupant to automatically adjust at least one property of the chair. Professional and amateur gamers often sit in a gaming chair for long hours while playing video games. This extended duration of sitting may cause short-term fatigue and lead to long-term problems such as diabetes. However, the only current solution is to pause the game and take a break, which may cause the player to lose momentum or give up time-critical opportunities within the game.

Exemplary embodiments of the invention provide systems and methods for automatically adjusting a chair in response to measurements of the occupant. The measurements may include biometric measurements. Various sensors may be used to obtain the measurements. Some non-limiting examples of the sensors may include visible cameras, infrared cameras, skin conductance sensors, pressure sensors, temperature sensors, humidity sensors, lidar systems, accelerometers, and magnetometers. Some non-limiting examples of the biometric measurements may include the pressure of the occupant on different sections of the chair, the temperature of the occupant, the humidity of the occupant, the heart rate of the occupant, the skin conductance of the occupant, the posture of the occupant, and the facial expression of the occupant. Some non-limiting examples of other measurements may include the distance from the occupant to a component outside of the chair, such as a table or a monitor.

The measurements may be provided to a processor that uses the measurements to assess the condition of the occupant and provide instructions to actuators to adjust the chair. In some examples the processor may provide the data to a trained artificial intelligence model. The instructions may cause the actuators to adjust various properties of the chair, such as the position, orientation, height, hardness, motion, and/or climate of different sections of the chair. These adjustments may be selected to stimulate the blood circulation of the occupant, provide physical support to the occupant, and/or correct the posture of the occupant. These adjustments may be small and unnoticeable by the occupant; however, they may keep the occupant alert and reduce detrimental health effects due to poor posture and extended periods of sitting in the chair.

According to an aspect of the invention, a system including a self-adjusting chair is provided. The system includes a chair that is configured to be adjustable to an occupant. The system also includes a plurality of sensors, wherein each sensor of the plurality of sensors is configured to measure a characteristic of the occupant and to transmit a signal that indicates the characteristic of the occupant. In addition, the system includes a plurality of actuators, wherein each actuator of the plurality of actuators is configured to adjust a property of the chair. Further, the system includes a controller that is configured to receive at least one signal from at least one sensor of the plurality of sensors and to instruct at least one actuator of the plurality of actuators to adjust at least one property of the chair based on at least one characteristic of the occupant.

The plurality of sensors may include a pressure sensor that is configured to measure a pressure that is applied by the occupant to a region of the chair. Alternatively or in addition, the plurality of sensors may include a temperature sensor that is configured to measure a temperature of the occupant and/or a humidity sensor that is configured to measure a humidity of the occupant. Alternatively or in addition, the plurality of sensors may include an accelerometer that is configured to measure a motion of the occupant.

Alternatively or in addition, the plurality of sensors may include a magnetometer that is configured to measure an orientation of the occupant. Alternatively or in addition, the plurality of sensors may include a lidar system that is configured to measure a posture of the occupant. Alternatively or in addition, the plurality of sensors may include a camera that is configured to measure a posture and/or a facial expression of the occupant.

The plurality of actuators may include a pneumatic pad that is configured to adjust at least one of a height, a hardness, or an elasticity profile of a region of the chair. Alternatively or in addition, the plurality of actuators may include a motor that is configured to adjust a position of the chair. Alternatively or in addition, the plurality of actuators may include a motor that is configured to adjust at least one of a position or an orientation of a section of the chair. Alternatively or in addition, the plurality of actuators may include a regulator that is configured to provide cooling or heating to a region of the chair. The controller may be further configured to instruct the at least one actuator based on results of inputting the at least one characteristic of the occupant into a trained artificial intelligence model.

According to another aspect of the invention, a method for automatically adjusting a chair is provided. The method includes measuring, by a sensor, a characteristic of an occupant of a chair; transmitting, by the sensor, a signal that indicates the characteristic of the occupant of the chair; receiving, by a controller, the signal; and instructing, by the controller, at least one actuator to adjust at least one property of the chair based on the characteristic of the occupant. The characteristic of the occupant may include a pressure applied by the occupant to the chair, a temperature of the occupant, a humidity of the occupant, a motion of the occupant, a skin conductance of the occupant, a posture of the occupant, an orientation of the occupant, or a facial expression of the occupant.

The method may also include measuring, by a plurality of sensors, a respective plurality of characteristics of the occupant of the chair; transmitting, by the plurality of sensors, a respective plurality of signals that indicate the respective plurality of characteristics of the occupant of the chair; receiving, by the controller, the plurality of signals; and instructing, by the controller, the at least one actuator to adjust the at least one property of the chair based on the plurality of characteristics of the occupant. Alternatively or in addition, the method may also include inputting the characteristic of the occupant into an artificial intelligence model in order to determine at least one adjustment of the at least one property of the chair.

According to yet another aspect of the invention, a system including a self-adjusting chair, a table, and a monitor is provided. The chair is configured to be adjustable to an occupant. The table is configured to be reachable by the occupant. The monitor is configured to be viewable by the occupant. The system also includes a plurality of sensors, wherein each sensor of the plurality of sensors is configured to measure a characteristic of the occupant and to transmit a signal that indicates the characteristic of the occupant. In addition, the system includes a plurality of actuators, wherein each actuator of the plurality of actuators is configured to adjust a property of the chair, the table, or the monitor. Further, the system includes a controller that is configured to receive at least one signal from at least one sensor of the plurality of sensors and to instruct at least one actuator of the plurality of actuators to adjust at least one property of the chair, the table, and/or the monitor based on at least one characteristic of the occupant.

The plurality of actuators may include a motor that is configured to adjust a position of the table. Alternatively or in addition, the plurality of actuators may include a motor that is configured to adjust a position and/or an orientation of the monitor.

Other objects, advantages, and novel features of the present invention will become apparent from the following detailed description of the invention when considered in conjunction with the accompanying drawings.

### BRIEF DESCRIPTION OF THE DRAWINGS

FIGS. 1A-1H show views of a self-adjusting chair according to exemplary embodiments of the invention.

FIG. 2 shows a perspective view of a system that includes the self-adjusting chair.

FIG. 3 shows a side view of the system that indicates directions of motion of various components within the system, along with schematic examples of positions of pneumatic pads and/or air nozzles that may be incorporated into the self-adjusting chair.

FIG. 4 shows a front view of the self-adjusting chair that indicates exemplary positions of the pneumatic pads.

FIG. 5 shows a front view of the self-adjusting chair that indicates exemplary positions of the air nozzles.

FIG. 6 shows a front view of the self-adjusting chair that indicates exemplary positions of sensors for measuring various characteristics of the occupant.

FIG. 7 shows a side view of a system architecture that includes the system shown in FIG. 2.

FIGS. 8A and 8B show a schematic diagram of a method for adjusting a property of the self-adjusting chair based on a measured characteristic of the occupant.

FIGS. 9A and 9B show a schematic diagram of a method for adjusting another property of the self-adjusting chair based on a measured characteristic of the occupant.

FIG. 10 shows an example of a method for automatically adjusting at least one property of the self-adjusting chair.

### DETAILED DESCRIPTION OF THE DRAWINGS

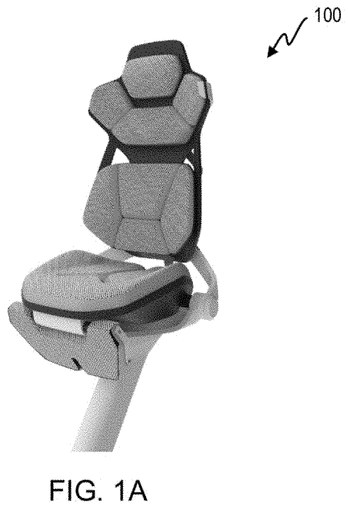

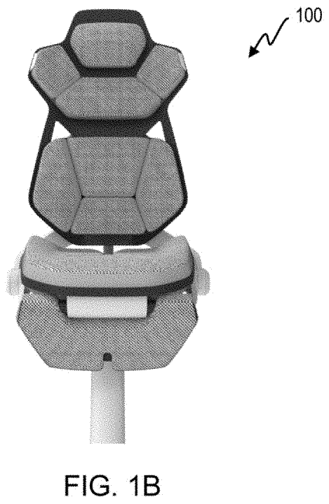

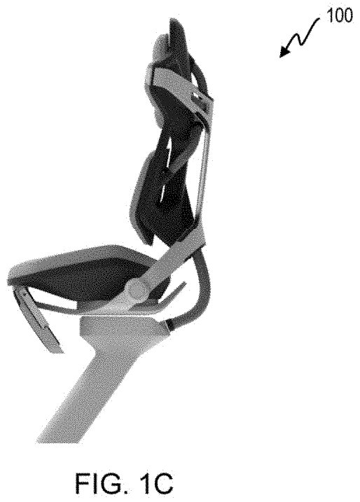

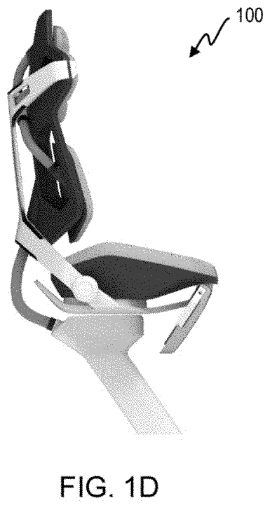

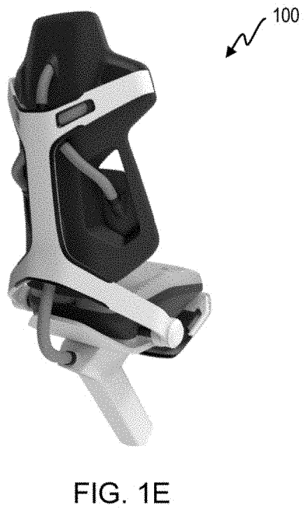

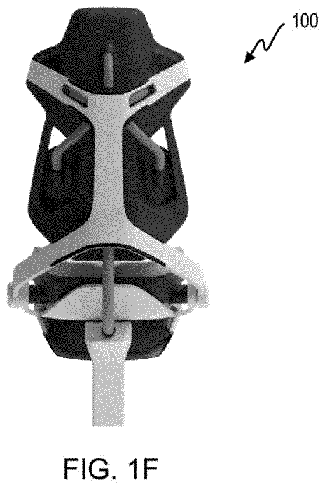

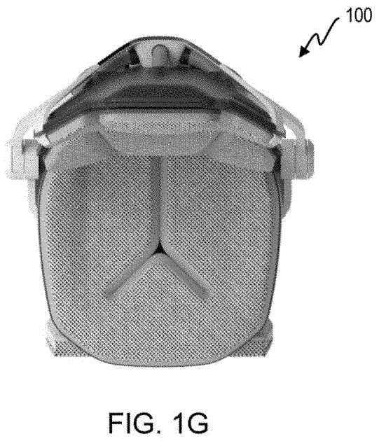

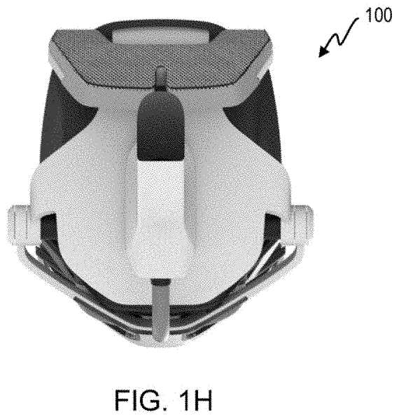

FIGS. 1A-1H show views of a self-adjusting chair 100 according to exemplary embodiments of the invention. In some examples the self-adjusting chair 100 may be a gaming chair. FIG. 1A shows a front perspective view of the self-adjusting chair 100, FIG. 1B shows a front view of the self-adjusting chair 100, FIG. 1C shows a first side view of the self-adjusting chair 100, and FIG. 1D shows a second side view of the self-adjusting chair 100. FIG. 1E shows a rear perspective view of the self-adjusting chair 100, FIG. 1F shows a rear view of the self-adjusting chair 100, FIG. 1G shows a top view of the self-adjusting chair 100, and FIG. 1H shows a bottom view of the self-adjusting chair 100. Additional views of the self-adjusting chair 100, including the placement of sensors and actuators, will be discussed below.

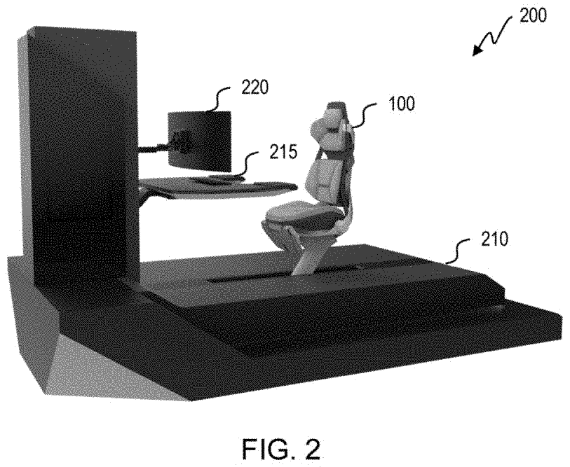

FIG. 2 shows a perspective view of a system 200 that includes the self-adjusting chair 100. In some examples the system 200 may be a gaming system. As shown in FIG. 2, the system 200 also includes a base 210 on which the self-adjusting chair 100 is mounted. The self-adjusting chair 100 may move forwards and backwards along a longitudinal direction of the base 210. In addition, the system includes a table 215 and a monitor 220. The self-adjusting chair 100 may be initially positioned such that the occupant can reach the table 215. In some examples a gaming console may be provided on the table 215. Further, the self-adjusting chair 100 may be initially positioned such that the occupant can view the monitor 220. In some examples a video game in which the occupant is participating may be displayed on the monitor 220.

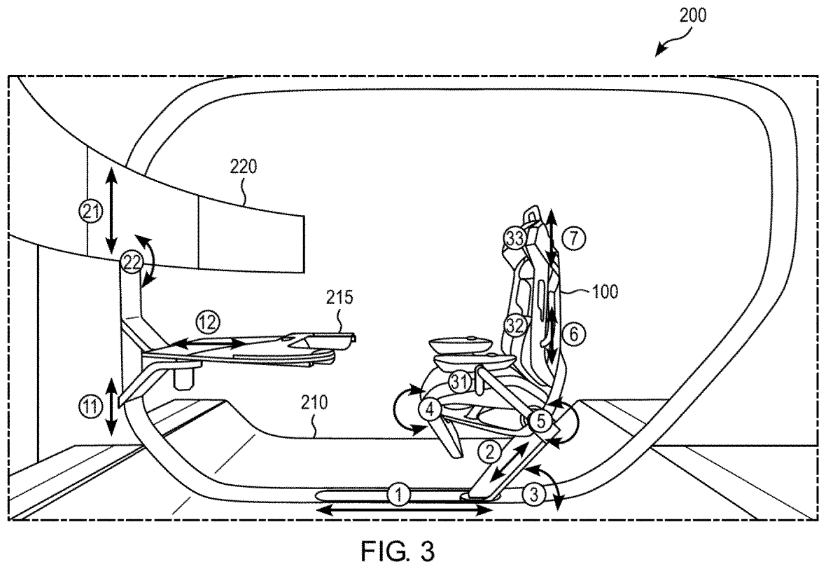

FIG. 3 shows a side view of the system 200 that indicates directions of motion of various components within the system 200. As shown in FIG. 3, the self-adjusting chair 100 may move forwards and backwards along a longitudinal direction 1 of the base 210. In addition, the height of the self-adjusting chair 100 may be modified by moving the self-adjusting chair 100 along a diagonal direction 2. The self-adjusting chair 100 may be moved along the longitudinal direction 1 and/or the diagonal direction 2 in order to position the self-adjusting chair 100 with respect to the table 215 and/or the monitor 220.

Various portions of the self-adjusting chair 100 may also be moved in order to adjust their position and/or orientation. The angle of the seat may be changed by rotating around an axis 3, the angle of the footrest may be changed by rotating around an axis 4, and the angle of the backrest may be changed by rotating around an axis 5. In addition, the height of the backrest lumbar may be changed by moving the backrest lumbar along a vertical direction 6, and the height of the headrest may be changed by moving the headrest along a vertical direction 7. The vertical direction 6 may be parallel to the vertical direction 7.

The position and/or orientation of the table 215 and the monitor 220 may also be adjusted. For example, the height of the table 215 may be modified by moving the table 215 along a vertical direction 11. In addition, the table 215 may move forwards and backwards along a longitudinal direction 12. Further, the height of the monitor 220 may be modified by moving the monitor 220 along a vertical direction 21, and the angle of the monitor 220 may be changed by rotating around an axis 22.

FIG. 3 also shows schematic examples of positions of pneumatic pads and/or air nozzles that may be incorporated into the self-adjusting chair 100. For example, pneumatic pads and air nozzles may be provided for the seat at position 31. Similarly, pneumatic pads and air nozzles may be provided for the backrest lumbar at position 32. In addition, air nozzles may be provided for the headrest at position 33. These positions are merely general locations and the actual number and placement of the pneumatic pads and/or air nozzles may vary.

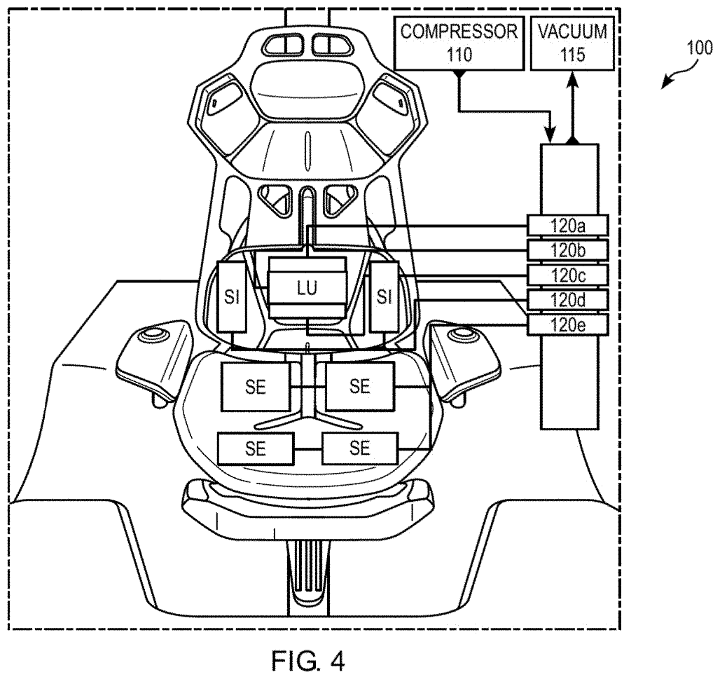

FIG. 4 shows a front view of the self-adjusting chair 100 that indicates exemplary positions of the pneumatic pads. For example, seat area pneumatic pads SE may be provided for the seat, side bolster pneumatic pads SI may be provided for the side of the backrest, and lumbar pneumatic pads LU may be provided for the backrest lumbar. The lumbar pneumatic pads LU may include three stacked lumbar pneumatic pads. Valves 120a, 120b, and 120c may control the three stacked lumbar pneumatic pads. Valve 120d may control the side bolster pneumatic pads SI, while valve 120e may control the seat area pneumatic pads SE. A compressor 110 and a vacuum 115 may be used in conjunction with the valves to individually adjust the height, hardness, and/or elasticity profile of the regions of the self-adjusting chair 100 where each of the respective pneumatic pads is located.

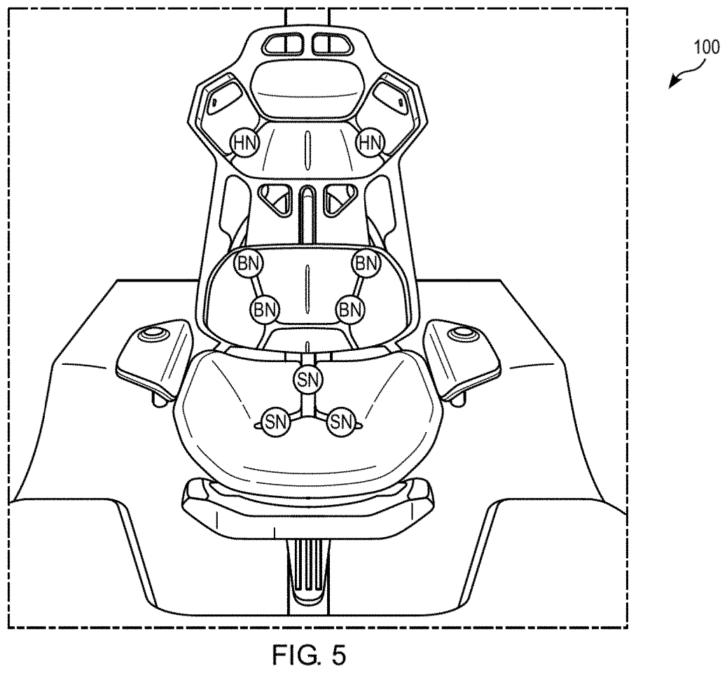

FIG. 5 shows a front view of the self-adjusting chair 100 that indicates exemplary positions of the air nozzles. For example, seat area air nozzles SN may be provided for the seat, backrest air nozzles BN may be provided for the backrest, and headrest air nozzles HN may be provided for the headrest. Each of the air nozzles may provide an air flow to the occupant. The air may be cooled or heated. The strength of the air flow may be regulated by one or more valves (not shown) that may be assigned to one or more of the air nozzles. Alternatively or in addition, electric heaters (not shown) may be used to provide heat to various regions of the self-adjusting chair 100.

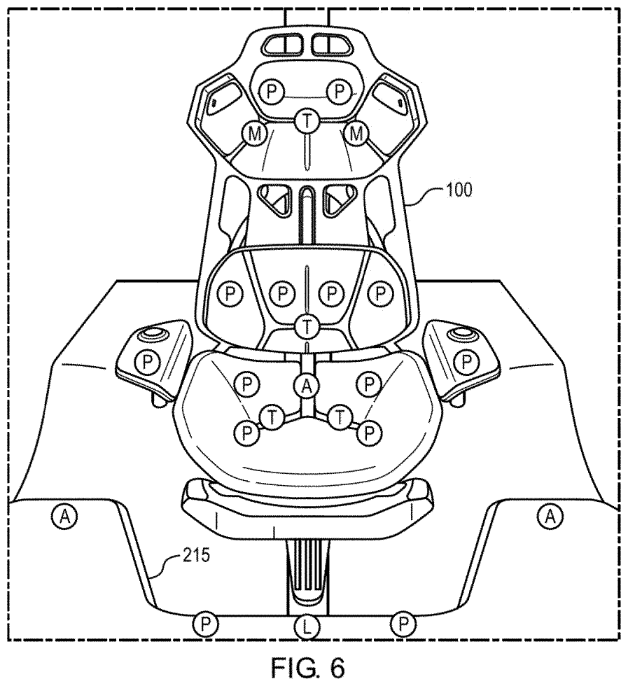

FIG. 6 shows a front view of the self-adjusting chair 100 that indicates exemplary positions of sensors for measuring various characteristics of the occupant. Some of the characteristics may include biometric measurements. For example, pressure sensors P may be used to measure the pressure that is applied by the occupant to various regions of the self-adjusting chair 100 and/or the table 215. The pressure sensors P may be provided for the table 215 and for the seat, backrest lumbar, side bolster, headrest, and armrests of the self-adjusting chair 100. Further, temperature and/or humidity sensors T may be used to measure the temperature and/or humidity of the occupant. The temperature and/or humidity sensors T may be provided for the seat, backrest, and headrest of the self-adjusting chair 100. The temperature and/or humidity sensors T may include separate temperature sensors and humidity sensors, or the temperature and humidity sensors may be integrated into combined units.

In addition, accelerometers A may be used to measure the motion of the occupant. The accelerometers A may be provided for the table 215 and for the seat of the self-adjusting chair 100. Further, magnetometers M may be used to measure the orientation of the occupant. The magnetometers M may be provided for the headrest of the self-adjusting chair 100. A lidar system L may also be used to measure the distance from the occupant to the table 215 and/or the posture of the occupant. The lidar system L may be provided for the table 215. In addition, cameras (not shown) may be used to measure the posture and/or the facial expression of the occupant. The cameras may use visible and/or infrared (IR) light.

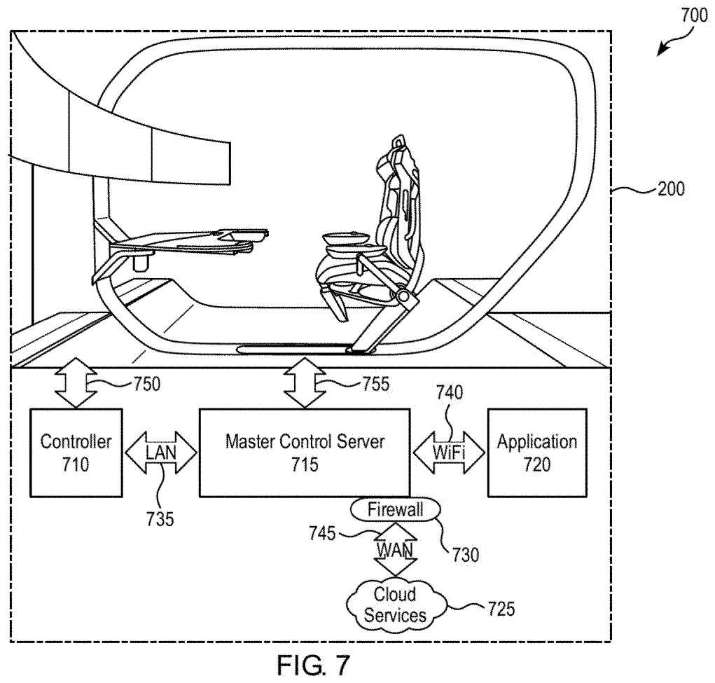

FIG. 7 shows a side view of a system architecture 700 that includes the system 200. The system architecture 700 also includes a controller 710, a master control server 715, an application 720, and cloud services 725. The controller 710 may communicate with the system 200 via connection 750 and the master control server 715 may communicate with the system 200 via connection 755. The connection 750 and the connection 755 may use any suitable communication method, including wired and wireless communication methods. In addition, the controller 710 may communicate with the master control server 715 via connection 735, which may be a local area network (LAN) connection. Further, the master control server 715 may communicate with the application 720 via connection 740, which may be a WiFi connection. In addition, the master control server 715 may communicate with the cloud services 725 via connection 745, which may be a wide area network (WAN) connection.

The master control server 715 may provide a control and communications hub for the system architecture 700. The master control server 715 may include various components such as a Modbus Transmission Control Protocol (TCP), a MySQL database, a media player, a Message Queuing Telemetry Transport (MQTT) broker, a virtual network computing (VNC) system, and an application programming interface (API). Third parties may access the master control server 715 via the API, which may be shielded by a firewall 730. The cloud services 725 may include a spectator cloud API and a service API. The application 720 may be hosted on a device such as a smartphone or a tablet, and may provide an interface to the master control server 715 for the occupant or a presenter.

The controller 710 may be a programmable logic controller (PLC), and may include a processor that receives signals from the sensors that indicate the various characteristics of the occupant discussed above. The processor may analyze the data within the signals to determine the condition of the occupant and/or to determine instructions to send to the actuators to adjust at least one property of the self-adjusting chair 100. The condition of the occupant may include the occupant's blood circulation, body temperature, posture, muscle strain, electrical conductivity, and/or sweating. In some examples, the processor may input the data into a trained artificial intelligence model. Various training methods may be used, such as supervised learning, unsupervised learning, and reinforcement learning. Further, various models may be trained, such as artificial neural networks, decision trees, support-vector machines, Bayesian networks, and genetic algorithms. In other examples, the processor may refer to pre-programmed modes for the occupant that indicate how to adjust the self-adjusting chair 100 based on at least one characteristic of the occupant. The processor may then send the instructions to at least one of the actuators to implement the adjustment or adjustments. In one example, if the temperature, humidity, and/or skin conductance of the occupant exceeds a threshold, the processor may instruct a valve that is assigned to at least one of the air nozzles HN, BN, or SN to provide cooled air to the occupant. In another example, if the distance of the occupant from the edge of the table 215 exceeds a threshold, the processor may instruct a motor that is assigned to the self-adjusting chair 100 to move the self-adjusting chair 100 closer to the table 215 along the longitudinal direction 1. Alternatively, the processor may instruct a motor that is assigned to the table 215 to move the table 215 closer to the self-adjusting chair 100 along the longitudinal direction 12. The controller 710 may also include an Ethernet client and an MQTT client.

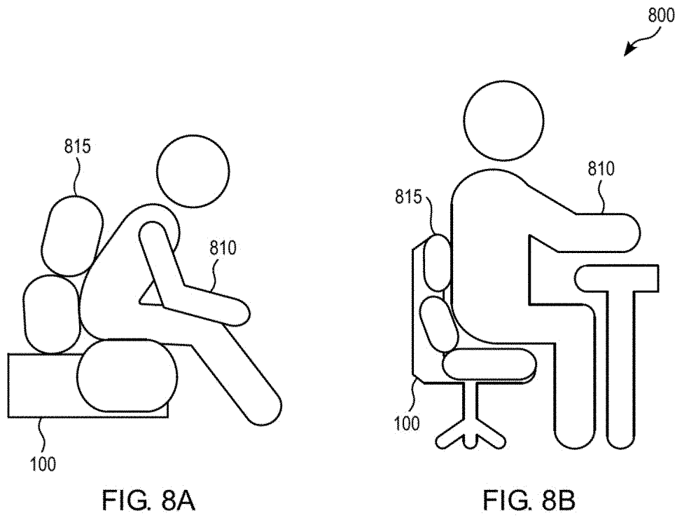

FIGS. 8A and 8B show a schematic diagram of a method for adjusting a property of the self-adjusting chair 100 based on a measured characteristic of the occupant. As shown in FIG. 8A, the occupant 810 is bending over and has poor posture for playing a video game. For example, the posture of the occupant 810 may be detected by a camera or the lidar system L. The controller 710 may receive a signal from the camera and/or the lidar system L that indicates the posture of the occupant 810. The controller 710 may then analyze the data within the signal to determine at least one adjustment to be made to the self-adjusting chair 100 to correct the posture of the occupant 810. As shown in FIG. 8B, the heights of pneumatic pads 815 in the backrest and seat of the self-adjusting chair may be reduced. In addition, the positions and/or the elasticity profiles of the pneumatic pads 815 may be changed in order to realign the back and/or legs of the occupant 810 to a more upright orientation.

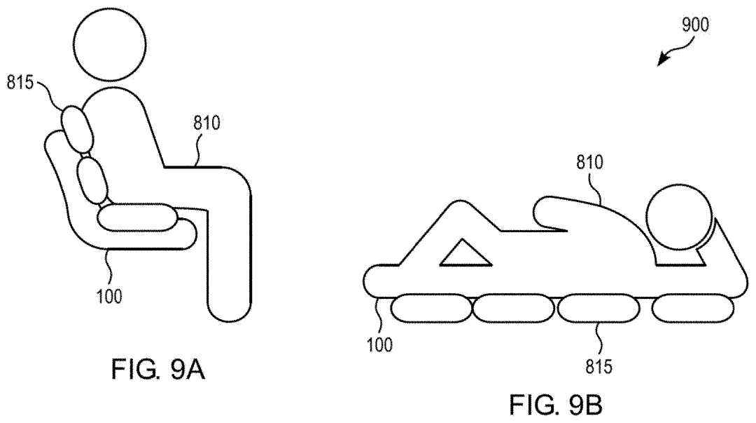

FIGS. 9A and 9B show a schematic diagram of a method for adjusting another property of the self-adjusting chair 100 based on a measured characteristic of the occupant. As shown in FIG. 9A, the occupant 810 is in a relaxed mode while taking a short break from playing a video game. The controller 710 may identify the relaxed mode based on information provided by the pressure sensors P, the camera, and/or the lidar system L. Accordingly, the controller 710 may send a signal to a motor instructing the motor to partially recline the backrest of the self-adjusting chair 100. As shown in FIG. 9B, the occupant 810 has moved to a sleep mode. Again, the controller 710 may identify the sleep mode based on information provided by the pressure sensors P, the camera, and/or the lidar system L. Accordingly, the controller 710 may send a signal to a motor instructing the motor to fully recline the backrest of the self-adjusting chair 100, and the controller may send a signal to the valves 120a-120e to soften the pneumatic pads 815 in order to provide for a more comfortable sleeping position. Here the pneumatic pads 815 may correspond to some or all of the pneumatic pads SE, SI, and LU shown in FIG. 4.

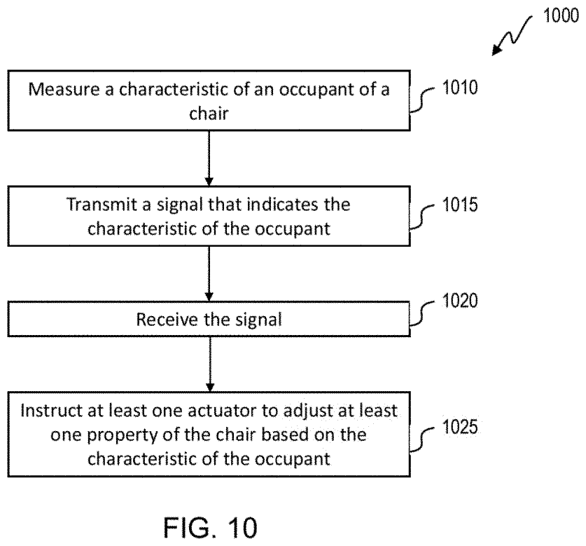

FIG. 10 shows an example of a method 1000 for automatically adjusting at least one property of the self-adjusting chair 100. As shown in FIG. 10, the method begins at block 1010, where a characteristic of an occupant of a chair is measured. A single characteristic or a plurality of characteristics may be measured by a single sensor or a plurality of sensors. For example, a pressure sensor may measure a pressure applied by the occupant to a region of the chair, a temperature sensor may measure a temperature of the occupant, a humidity sensor may measure a humidity of the occupant, a skin conductance sensor may measure a skin conductance of the occupant, an accelerometer may measure a motion of the occupant, a magnetometer may measure an orientation of the occupant, a lidar system may measure a posture of the occupant and/or a distance of the occupant from an object outside of the chair, and/or a camera may measure a posture and/or a facial expression of the occupant.

The sensor then transmits a signal that indicates the characteristic of the occupant at block 1015. The signal may indicate the characteristic of the occupant at a single point in time or over a period of time. Alternatively, the sensor may transmit a plurality of signals over time that indicate the characteristic of the occupant over time. If the sensor measures more than one characteristic of the occupant, the signal may indicate some or all of the characteristics that were measured by the sensor.

The controller then receives the signal from the sensor at block 1020. The controller may receive a plurality of signals from one sensor. Alternatively or in addition, the controller may receive one signal or a plurality of signals from a plurality of sensors. Each signal may indicate one characteristic of the occupant or a plurality of characteristics of the occupant that were measured by the sensor.

The controller then instructs at least one actuator to adjust at least one property of the chair based on the characteristic of the occupant at block 1025. The controller may analyze the measured characteristic or characteristics of the occupant to assess the condition of the occupant and determine instructions to send to at least one actuator based on the condition of the occupant. Alternatively or in addition, the controller may refer to the measured characteristic or characteristics of the occupant and determine instructions to send to at least one actuator by using a look-up table or another reference method. Further, the controller may determine the instructions by providing the measured characteristic or characteristics of the occupant to a trained artificial intelligence model and receiving the instructions from the trained artificial intelligence model. The controller may then send the instructions to at least one of the actuators to implement the adjustment or adjustments to the chair. The controller may also send instructions to other components, such as a table or monitor within the system, to adjust a property or properties of the other components based on the measured characteristic or characteristics of the occupant.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A system comprising:
a chair that is configured to be adjustable to an occupant;
a plurality of sensors, wherein each sensor of the plurality of sensors is configured to measure a characteristic of the occupant and to transmit a signal that indicates the characteristic of the occupant;
a plurality of actuators, wherein each actuator of the plurality of actuators is configured to adjust a property of the chair; and
a controller that is configured to receive at least one signal from at least one sensor of the plurality of sensors and to instruct at least one actuator of the plurality of actuators to adjust at least one property of the chair based on at least one characteristic of the occupant.

2. The system according to claim 1, wherein the plurality of sensors comprises a pressure sensor that is configured to measure a pressure that is applied by the occupant to a region of the chair.

3. The system according to claim 1, wherein the plurality of sensors comprises at least one of a temperature sensor that is configured to measure a temperature of the occupant, a humidity sensor that is configured to measure a humidity of the occupant, or a skin conductance sensor that is configured to measure a skin conductance of the occupant.

4. The system according to claim 1, wherein the plurality of sensors comprises an accelerometer that is configured to measure a motion of the occupant.

5. The system according to claim 1, wherein the plurality of sensors comprises a magnetometer that is configured to measure an orientation of the occupant.

6. The system according to claim 1, wherein the plurality of sensors comprises a lidar system that is configured to measure a posture of the occupant.

7. The system according to claim 1, wherein the plurality of sensors comprises a camera that is configured to measure a posture of the occupant.

8. The system according to claim 1, wherein the plurality of sensors comprises a camera that is configured to measure a facial expression of the occupant.

9. The system according to claim 1, wherein the plurality of actuators comprises a pneumatic pad that is configured to adjust at least one of a height, a hardness, or an elasticity profile of a region of the chair.

10. The system according to claim 1, wherein the plurality of actuators comprises a motor that is configured to adjust a position of the chair.

11. The system according to claim 1, wherein the plurality of actuators comprises a motor that is configured to adjust at least one of a position or an orientation of a section of the chair.

12. The system according to claim 1, wherein the plurality of actuators comprises a regulator that is configured to provide cooling or heating to a region of the chair.

13. The system according to claim 1, wherein the controller is further configured to instruct the at least one actuator based on results of inputting the at least one characteristic of the occupant into a trained artificial intelligence model.

14. A method comprising:
measuring, by a sensor, a characteristic of an occupant of a chair;
transmitting, by the sensor, a signal that indicates the characteristic of the occupant of the chair;
receiving, by a controller, the signal; and
instructing, by the controller, at least one actuator to adjust at least one property of the chair based on the characteristic of the occupant.

15. The method according to claim 14, wherein the characteristic of the occupant comprises a pressure applied by the occupant to the chair, a temperature of the occupant, a humidity of the occupant, a motion of the occupant, a skin conductance of the occupant, a posture of the occupant, an orientation of the occupant, or a facial expression of the occupant.

16. The method according to claim 14, further comprising:
measuring, by a plurality of sensors, a respective plurality of characteristics of the occupant of the chair;
transmitting, by the plurality of sensors, a respective plurality of signals that indicate the respective plurality of characteristics of the occupant of the chair;
receiving, by the controller, the plurality of signals; and
instructing, by the controller, the at least one actuator to adjust the at least one property of the chair based on the plurality of characteristics of the occupant.

17. The method according to claim 14, further comprising inputting the characteristic of the occupant into an artificial intelligence model in order to determine at least one adjustment of the at least one property of the chair.

18. A system comprising:
a chair that is configured to be adjustable to an occupant;
a table that is configured to be reachable by the occupant;
a monitor that is configured to be viewable by the occupant;
a plurality of sensors, wherein each sensor of the plurality of sensors is configured to measure a characteristic of the occupant and to transmit a signal that indicates the characteristic of the occupant;
a plurality of actuators, wherein each actuator of the plurality of actuators is configured to adjust a property of the chair, the table, or the monitor; and
a controller that is configured to receive at least one signal from at least one sensor of the plurality of sensors and to instruct at least one actuator of the plurality of actuators to adjust at least one property of at least one of the chair, the table, or the monitor based on at least one characteristic of the occupant.

19. The system according to claim 18, wherein the plurality of actuators comprises a motor that is configured to adjust a position of the table.

20. The system according to claim 18, wherein the plurality of actuators comprises a motor that is configured to adjust at least one of a position or an orientation of the monitor.
